(19) United States
(12) Patent Application Publication
(10) Pub. No.: US 2018/0029553 A1
(43) Pub. Date: Feb. 1, 2018

(54) VEHICLE-MOUNTED DEVICE, PORTABLE TERMINAL, AND EMERGENCY NOTIFICATION SYSTEM

(71) Applicant: Mitsubishi Electric Corporation, Tokyo (JP)

(72) Inventor: Kazuya HAMAKAMI, Tokyo (JP)

(73) Assignee: Mitsubishi Electric Corporation, Tokyo (JP)

(21) Appl. No.: 15/544,480

(22) PCT Filed: Apr. 22, 2015
(86) PCT No.: PCT/JP2015/062209

§ 371 Date: Jul. 18, 2017

(51) Int. Cl. B60R 21/013

(52) U.S. Cl. CPC B60R 21/013; B60R 2021/0027

(57) ABSTRACT

A vehicle-side communication unit wirelessly communicates with a portable terminal and receives the personal information of a holder having the portable terminal. A personal information analysis unit analyzes the personal information of the holder received by the vehicle-side communication unit, and determines information necessary for responding to an accident and a contact who is to be notified of the information. An emergency contact unit is an element that sends the information necessary for responding to the accident to the contact determined by the personal information analysis unit.

### TECHNICAL FIELD

The invention relates to a vehicle-mounted device that notifies a contact who performs a response after a vehicle collision accident of information related to a victim of the accident, a portable terminal that sends the information related to the victim to the vehicle-mounted device, and an emergency notification system that includes the vehicle-mounted device and the portable terminal.

### BACKGROUND ART

For example, Patent Literature 1 describes a system in which, when an accident in which a vehicle collides with a pedestrian occurs, accident information of a passenger of the vehicle and accident information of the pedestrian are detected, and an emergency notification center is notified of the accident information. Note that the accident information of the passenger is information indicating a situation when danger has occurred to the passenger on the basis of an impact on the passenger caused by the collision of the vehicle. For example, pieces of information such as the number of passengers of the vehicle, use of a seat belt, a collision direction, the presence or absence of multiple collisions, the presence or absence of a rollover, and a difference between vehicle speeds before and after the collision, are included. The accident information of the pedestrian is information indicating the situation of the pedestrian who collides with the vehicle, and includes, e.g., the vehicle speed of the vehicle immediately before the collision, the acceleration of a bumper, impact energy calculated from the acceleration, and the front image of the vehicle.

### CITATION LIST

### Patent Literature

Patent Literature 1: Japanese Patent Application Laid-open No. 2010-244167

### SUMMARY OF INVENTION

### Technical Problem

As described above, in the conventional technology represented by Patent Literature 1, the situation of the victim of the accident is determined from the information that can be detected on the vehicle side.

In contrast, in the scene of an actual accident response, personal information such as the blood type, presence or absence of a chronic illness, date of birth, and address of the victim is necessary in order to, e.g., adequately treat the victim.

However, these pieces of information cannot be detected on the vehicle side, and it has not been possible to acquire the pieces of information unless the pieces of information are confirmed from the belongings of the victim or are obtained from the victim or concerned parties such as the family of the victim. As a result, in some cases, it has not been possible to smoothly perform the response after the accident in the conventional emergency notification system.

The invention solves the above problem, and an object thereof is to obtain a vehicle-mounted device, a portable terminal, and an emergency notification system capable of smoothly performing a response after an accident.

### Solution to Problem

A vehicle-mounted device according to the invention includes a vehicle-side communication unit, a personal information analysis unit, and an emergency contact unit.

The vehicle-side communication unit wirelessly communicates with a portable terminal and receives personal information of a holder of the portable terminal. The personal information analysis unit analyzes the personal information of the holder received by the vehicle-side communication unit, and determines information necessary for responding to an accident as well as a contact who is to be notified of the information. The emergency contact unit sends the information necessary for responding to the accident to the contact determined by the personal information analysis unit.

### Advantageous Effects of Invention

According to the invention, the vehicle-mounted device acquires the personal information of the holder of the portable terminal by the wireless communication with the portable terminal, and analyzes the personal information and determines the information necessary for responding to the accident as well as the contact who is to be notified of the information. With this, it is possible to speedily perform the notification of the information necessary for responding to the accident based on the personal information of the victim, and smoothly perform the response after the accident.

### BRIEF DESCRIPTION OF DRAWINGS

FIG. 1 is a block diagram showing the configuration of an emergency notification system according to Embodiment 1 of the invention, in which FIG. 1A is a block diagram showing the configuration of each of a vehicle-mounted device and a portable terminal of the emergency notification system and

FIG. 1B is a view showing the hardware configuration of the vehicle-mounted device.

FIG. 2 is a view showing an example of personal information retained by the portable terminal in FIG. 1.

FIG. 3 is a flowchart showing the operation of the portable terminal in FIG. 1.

FIG. 4 is a flowchart showing the operation of the vehicle-mounted device in FIG. 1.

### DESCRIPTION OF EMBODIMENTS

Hereinbelow, in order to describe the invention in greater detail, an embodiment will be described according to the accompanying drawings.

### Embodiment 1

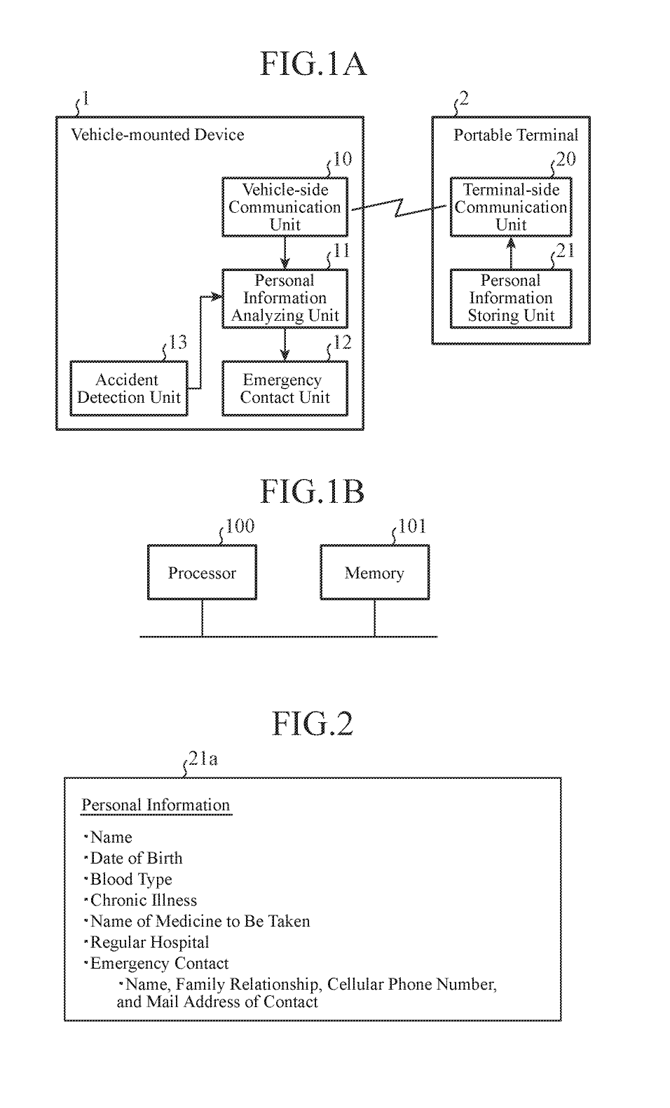

FIG. 1 is a block diagram showing the configuration of an emergency notification system according to Embodiment 1 of the invention. FIG. 1A is a block diagram showing the configuration of each of a vehicle-mounted device 1 and a portable terminal 2 of the emergency notification system, and FIG. 1B is a view showing the hardware configuration of the vehicle-mounted device 1. In addition, FIG. 2 is a view showing an example of personal information 21a retained by the portable terminal 2.

The vehicle-mounted device 1 is a device mounted on a vehicle and may be a device dedicated for emergency notification, but may also be implemented as one function of a navigation device mounted on the vehicle.

In addition, the vehicle-mounted device 1 may also be a portable terminal held by a vehicle passenger such as a smart phone. Further, a holder of the portable terminal 2 may get in a light vehicle such as a bicycle or a motorcycle, but the following description will be made with the assumption that the holder is a pedestrian.

As shown in FIG. 1A, the vehicle-mounted device 1 includes a vehicle-side communication unit 10, a personal information analysis unit 11, an emergency contact unit 12, and an accident detection unit 13.

The vehicle-side communication unit 10 wirelessly communicates with the portable terminal 2 and receives the personal information 21a of the holder of the portable terminal 2. As a wireless system between the vehicle-side communication unit 10 and a terminal-side communication unit 20, NFC (Near Field Communication) capable of communication within a distance range of about several tens of cm or the like is used.

By using the above wireless system, it is possible to anticipate that a vehicle and a pedestrian exist within this distance range due to the contact or collision of the vehicle with the pedestrian.

That is, in the case where the vehicle on which the vehicle-mounted device 1 is mounted and the pedestrian who holds the portable terminal 2 exist within the distance range in which the contact between the vehicle and the pedestrian is anticipated, the vehicle-side communication unit 10 receives the personal information 21a from the portable terminal 2 by communicating with the terminal-side communication unit 20 using the above near field communication.

Note that the invention can also be applied to the case where a movable body that moves together with the holder of the portable terminal 2 and the vehicle exist within the distance range described above. As the movable body, as described above, a light vehicle such as a bicycle and a motor cycle is conceivable.

In addition, in the case where it is determined that the vehicle is moving, on the basis of vehicle information including a vehicle speed, or change of the position of the vehicle, and the distance range described above is reached, the vehicle-side communication unit 10 may wirelessly communicate with the portable terminal 2. For example, in the case where the moving vehicle and the pedestrian exist within the distance range described above, it is anticipated that the vehicle has collided with the pedestrian, and hence the vehicle-side communication unit 10 acquires the personal information 21a from the portable terminal 2. In contrast, even when the parked vehicle and the pedestrian exist within the distance range described above, the vehicle does not collide with the pedestrian, and hence the acquisition of the personal information 21a is not performed.

The personal information analysis unit 11 analyzes the personal information 21a of the pedestrian received by the vehicle-side communication unit 10, and determines information necessary for responding to an accident and a contact who is to be notified of the information.

The personal information 21a is information in which the personal information of the holder of the portable terminal 2 is described for each of predetermined items. As shown in FIG. 2, information of each of the items such as the name, date of birth, blood type, chronic illness, name of medicine to be taken, regular hospital, and emergency contact of the holder of the portable terminal 2 is described. For example, the personal information analysis unit 11 performs text analysis of the personal information 21a to extract the information of each item, and determines the contact corresponding to the extracted information of the item by referring to corresponding data of the item of the personal information 21a and the contact who is to be notified of the information of the item.

The information including the information of the item determined in this manner is the information necessary for responding to the accident, and the contact corresponding to the information is the contact who is to be notified of the information necessary for responding to the accident.

Note that, in the item of the emergency contact shown in FIG. 2, the name, family relationship, cellular phone number, and mail address of the contact are described.

Consequently, the personal information analysis unit 11 may determine that a fixed sentence meaning that the holder of the portable terminal 2 is involved in an accident is the information necessary for responding to the accident, and may determine that the cellular phone number and the mail address described in the item are the contacts.

In addition, the personal information 21a may be determined as the information necessary for responding to the accident as it is, and an emergency notification center responding to a vehicle accident or the like may be determined as the contact.

The emergency contact unit 12 is an element that sends the information necessary for responding to the accident to the contact determined by the personal information analysis unit 11. In the emergency contact unit 12, for example, the address of a communication device of each of the contacts related to the accident response is pre-registered. The emergency contact unit 12 determines the address corresponding to the contact input from the personal information analysis unit 11 from among the addresses of the communication devices of the individual contacts related to the accident response, and accesses the address and sends the information necessary for responding to the accident to the address.

The accident detection unit 13 detects the accident caused by the contact between the vehicle on which the vehicle-mounted device 1 is mounted and the holder of the portable terminal 2. The occurrence of the accident is detected from, e.g., actuation of an air bag, acceleration sensed by an acceleration sensor, and a camera image of the periphery of the vehicle.

Note that, when the accident detection unit 13 detects the occurrence of the accident, the accident detection unit 13 notifies the personal information analysis unit 11 of the occurrence of the accident. The personal information analysis unit 11 does not analyze the personal information in the case where the accident detection unit 13 does not detect the accident, and analyzes the personal information in the case where the accident detection unit 13 detects the accident.

In addition, the accident detection unit 13 may detect accident information indicating the position and situation of the accident. When the occurrence of the accident is detected, the current position of the vehicle is determined from position information acquisition means such as a GPS (global positioning system) receiver, and a camera image on the side of the contact with the pedestrian is extracted as information indicating the situation of the accident from among the images of a camera that images the periphery of the vehicle.

The personal information analysis unit 11 may determine that the accident information detected by the accident detection unit 13 is the information necessary for responding to the accident, and may determine the contact who is to be notified of the information.

Note that, as shown in FIG. 1B, each of the vehicle-side communication unit 10, the personal information analysis unit 11, the emergency contact unit 12, and the accident detection unit 13 is implemented by executing a program stored in a memory 101 by a processor 100.

In addition, a plurality of processors and a plurality of memories may cooperate with each other to execute the above function.

Next, operations will be described.

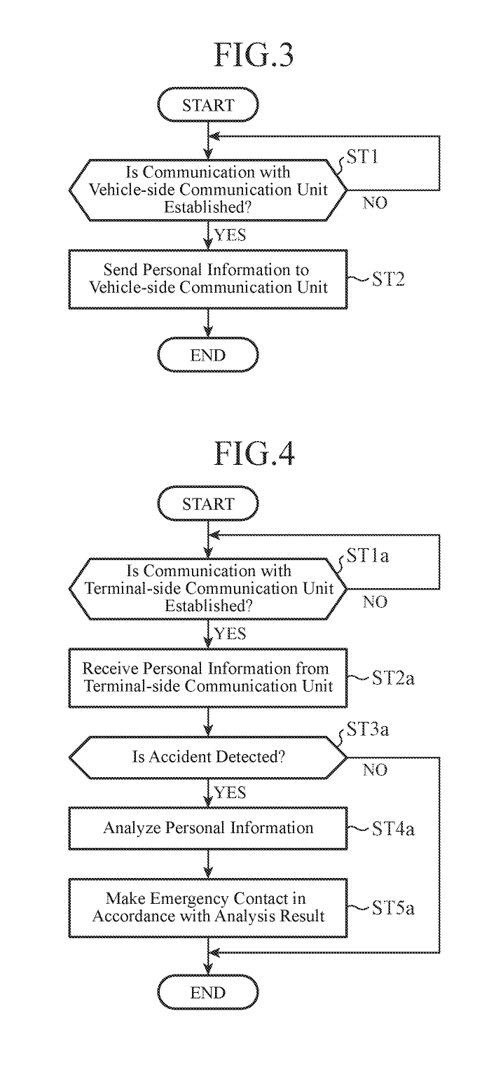

FIG. 3 is a flowchart showing the operation of the portable terminal 2, and shows the operation when a minor collision with the vehicle on which the vehicle-mounted device 1 is mounted has occurred.

First, the terminal-side communication unit 20 of the portable terminal 2 polls the communication with the vehicle-side communication unit 10 of the vehicle-mounted device 1 at all times. The vehicle-side communication unit 10 also polls the communication with the terminal-side communication unit 20 at all times. With this, the terminal-side communication unit 20 is ready to determine whether or not the vehicle on which the vehicle-mounted device 1 is mounted and the pedestrian who holds the portable terminal 2 exist within the distance range in which the contact between the vehicle and the pedestrian is anticipated, i.e., whether or not the communication with the vehicle-side communication unit 10 is established (Step ST1).

When the communication with the vehicle-side communication unit 10 is not established (Step ST1; NO), the process in Step ST1 is repeated.

In contrast, when the communication with the vehicle-side communication unit 10 is established (Step ST1; YES), the terminal-side communication unit 20 reads the personal information 21a of the holder from a personal information storing unit 21, and sends the personal information 21a to the vehicle-mounted device 1 (Step ST2).

Note that, in Step ST1, the case where the vehicle-side communication unit 10 and the terminal-side communication unit 20 poll the communications mutually is shown, but the invention is not limited thereto.

For example, the vehicle-side communication unit 10 may start the polling when a situation in which the pedestrian or the like is close to the vehicle arises by using corner sensors provided in the vehicle or a camera that images the periphery of the vehicle.

FIG. 4 is a flowchart showing the operation of the vehicle-mounted device 1, and shows the operation when a minor collision with the pedestrian who holds the portable terminal 2 has occurred.

First, as described above, the vehicle-side communication unit 10 of the vehicle-mounted device 1 polls the communication with the terminal-side communication unit 20 of the portable terminal 2 at all times. In addition, the terminal-side communication unit 20 also polls the communication with the vehicle-side communication unit 10 at all times. With this, the vehicle-side communication unit 10 is ready to determine whether or not the vehicle on which the vehicle-mounted device 1 is mounted and the pedestrian who holds the portable terminal 2 exist within the distance range in which the contact between the vehicle and the pedestrian is anticipated, i.e., whether or not the communication with the terminal-side communication unit 20 is established (Step ST1a).

In the case where the communication with the terminal-side communication unit 20 is not established (Step ST1a; NO), the process in Step STla is repeated.

In contrast, in the case where the communication with the terminal-side communication unit 20 is established (Step ST1a; YES), the vehicle-side communication unit 10 receives the personal information 21a of the holder sent from the terminal-side communication unit 20 in Step ST2 in FIG. 3 (Step ST2a).

When the personal information analysis unit 11 receives the personal information 21a received from the portable terminal 2 by the vehicle-side communication unit 10, the personal information analysis unit 11 determines whether or not the accident detection unit 13 detects the occurrence of the accident (Step ST3a). Herein, in the case where the accident is not detected (Step ST3a; NO), the personal information analysis unit 11 determines that false information is received from the portable terminal 2, and ends the process after discarding the personal information 21a.

In contrast, in the case where the accident is detected (Step ST3a; YES), the personal information analysis unit 11 analyzes the personal information 21a, and determines the information necessary for responding to the accident and the contact who is to be notified of the information (Step ST4a).

For example, information described in the items of the name, date of birth, and emergency contact of a victim in the personal information 21a is extracted as the information necessary for responding to the accident, and “police” is determined as the contact who is to be notified of the extracted information described above by referring to the corresponding data described above.

In addition, information described in each of the items such as the blood type, chronic illness, name of medicine to be taken, and regular hospital of the victim is extracted, and “hospital” is determined as the contact who is to be notified of the information.

The emergency contact unit 12 makes emergency contact on the basis of the result of the analysis of the personal information analysis unit 11 (Step ST5a). For example, the emergency contact unit 12 determines the address corresponding to the contact received from the personal information analysis unit 11 from among the pre-registered addresses of the communication devices of the individual contacts related to the accident response, and accesses the address and sends the information necessary for responding to the accident to the address.

In the case where pieces of the information necessary for responding to the accident are the name, date of birth, and emergency contact of the victim, and the contact is “police”, the emergency contact unit 12 accesses a communication device for emergency notification managed by the police and sends the information necessary for responding to the accident to the communication device.

In the case where pieces of the information necessary for responding to the accident are the blood type, chronic illness, name of medicine to be taken, and regular hospital of the victim, and the contact is “hospital”, the emergency contact unit 12 accesses a communication device for emergency notification managed by a hospital, and sends the information necessary for responding to the accident to the communication device. With this, when the victim is treated on the hospital side, it is possible to grasp usable medicine based on the chronic illness of the victim. In addition, it is also possible to make an inquiry at the regular hospital about the treatment and like.

These processes eliminate the necessity for asking the victim himself/herself or parties concerned such as the family of the victim about necessary information, and can be executed on the basis of the information necessary for responding to the accident obtained from the vehicle-mounted device 1.

In addition, the emergency contact described in the personal information 21a may be sent to the hospital as the information necessary for responding to the accident. For example, in the case where the victim needs to have an operation and it is necessary to get the consent of the family, the hospital side can check with the family of the victim based on the emergency contact.

For the family side of the victim, in the case where the victim cannot go to the office due to the accident and the office informs the family of the absence of the victim, the family worries about the safety of the victim and the emotional strain of the family is significantly increased.

To cope with this, when the accident is detected by the accident detection unit 13, the personal information analysis unit 11 immediately determines the address of a communication device such as the portable terminal or personal computer of the family side of the victim from the emergency contact. Subsequently, the emergency contact unit 12 accesses the address and sends the accident information detected by the accident detection unit 13 to the address.

With this, it is possible for the family side to grasp the situation of the victim immediately after the occurrence of the accident, and hence it is possible to reduce the emotional strain described above.

However, sending the accident information only when the accident occurs actually prompts fears. In this case, for example, the emergency contact unit 12 sends the emergency contact of the victim to a communication device mounted on an ambulance. With this, it becomes possible for the communication device of the ambulance to inform the family side of the situation of the victim who is being taken to the hospital on a real-time basis.

Note that FIG. 1A shows the case where the vehicle-mounted device 1 includes the accident detection unit 13 but, in the case where the contact between the vehicle and the pedestrian is anticipated with the establishment of the communication between the vehicle-side communication unit 10 and the terminal-side communication unit 20, the accident detection unit 13 may be omitted.

Thus, the vehicle-mounted device 1 according to Embodiment 1 includes the vehicle-side communication unit 10, the personal information analysis unit 11, and the emergency contact unit 12.

The vehicle-side communication unit 10 wirelessly communicates with the portable terminal 2 and receives the personal information 21a of the holder of the portable terminal 2. The personal information analysis unit 11 analyzes the personal information 21a received by the vehicle-side communication unit 10, and determines the information necessary for responding to the accident and the contact who is to be notified of the information. The emergency contact unit 12 sends the information necessary for responding to the accident to the contact determined by the personal information analysis unit 11.

With this configuration, the vehicle-mounted device 1 acquires the personal information 21a of the holder of the portable terminal 2 by the wireless communication with the portable terminal 2, and analyzes the personal information 21a and determines the information necessary for responding to the accident and the contact who is to be notified of the information. With this, it is possible to speedily perform the notification of the information necessary for responding to the accident based on the personal information 21a of the victim, and smoothly perform the response after the accident.

In addition, in the vehicle-mounted device 1 according to Embodiment 1, in the case where the vehicle on which the vehicle-mounted device 1 is mounted and the holder of the portable terminal 2 exist within the distance range in which the contact between the vehicle and the holder is anticipated, the vehicle-side communication unit 10 wirelessly communicates with the portable terminal 2 and receives the personal information 21a of the holder.

With this configuration, at a timing at which the communication between the vehicle-side communication unit 10 and the terminal-side communication unit 20 is established, it is possible to determine that the vehicle has come in contact with or collided with the holder of the portable terminal 2.

Further, the vehicle-mounted device 1 according to Embodiment 1 includes the accident detection unit 13 that detects the accident caused by the contact between the vehicle and the holder of the portable terminal 2.

The personal information analysis unit 11 does not analyze the personal information 21a when the accident detection unit 13 does not detect the accident, and analyzes the personal information 21a when the accident detection unit 13 detects the accident.

With this configuration, it is possible to prevent the personal information 21a from being processed by mistake when the accident caused by the contact between the vehicle and the pedestrian does not occur.

In addition, in the vehicle-mounted device 1 according to Embodiment 1, the accident detection unit 13 detects the accident information indicating the position and situation of the accident.

The personal information analysis unit 11 determines that the accident information detected by the accident detection unit 13 is the information necessary for responding to the accident, and determines the contact who is to be notified of the information.

With this configuration, it is possible to notify the contact for the emergency notification of the position and situation of the accident.

Further, the portable terminal 2 according to Embodiment 1 includes the terminal-side communication unit 20 and the personal information storing unit 21. The personal information storing unit 21 stores the personal information 21a of the holder. In the case where the vehicle on which the vehicle-mounted device 1 is mounted and the holder exist within the distance range in which the contact between the vehicle and the holder is anticipated, the terminal-side communication unit 20 wirelessly communicates with the vehicle-mounted device 1, and sends the personal information 21a stored in the personal information storing unit 21.

With this configuration, in cooperation with the vehicle-mounted device 1, the same effects as those described above can be obtained.

In addition, as shown in FIG. 1A, the emergency notification system according to Embodiment 1 includes the vehicle-mounted device 1 and the portable terminal 2. With this configuration, the vehicle-mounted device 1 and the portable terminal 2 cooperate with each other, and the same effects as those described above can be obtained.

Note that it is possible to modify any components in the embodiment, or omit any components in the embodiment within the scope of the invention.

### INDUSTRIAL APPLICABILITY

The vehicle-mounted device according to the invention is capable of smoothly performing the response to the collision accident involving a vehicle and a pedestrian, and hence the vehicle-mounted device is suitably used in an emergency notification system specialized in the collision accident involving a vehicle and a pedestrian or the like.

### REFERENCE SIGNS LIST

1 vehicle-mounted device

2 portable terminal

10 vehicle-side communication unit

11 personal information analysis unit

12 emergency contact unit

13 accident detection unit

20 terminal-side communication unit

21 personal information storing unit

21a personal information

100 processor

101 memory

1-6. (canceled)

7. A vehicle-mounted device comprising:
a vehicle-side communicator provided in a vehicle to wirelessly communicate with a portable terminal and receive personal information of a holder of the portable terminal;
a personal information analyzer to analyze the personal information of the holder received by the vehicle-side communicator, and determining information necessary for responding to an accident and a contact who is to be notified of the information; and
an emergency contact unit to send the information necessary for responding to the accident to the contact determined by the personal information analyzer, wherein
the vehicle-side communicator wirelessly communicates with the portable terminal and receives the personal information of the holder in a case where the vehicle and the holder or a movable body that moves together with the holder exist within a distance range in which a minor collision between the vehicle and the holder or the movable body is anticipated.

8. The vehicle-mounted device according to claim 7, further comprising:
an accident detector to detect a minor collision between the vehicle and the holder or the movable body that moves together with the holder, wherein
the personal information analyzer does not analyze the personal information in a case where the accident detector does not detect an accident, and analyzes the personal information in a case where the accident detector detects an accident.

9. The vehicle-mounted device according to claim 7, wherein
the vehicle-side communicator wirelessly communicates with the portable terminal and receives the personal information of the holder in a case where the vehicle-side communicator determines that the vehicle and the holder or the movable body that moves together with the holder exist within the distance range in which a minor collision between the vehicle and the holder or the movable body is anticipated, on a basis of vehicle information and position information of the portable terminal, and
the personal information analyzer analyzes the personal information of the holder received by the vehicle-side communicator and determines the information necessary for responding to the accident and the contact who is to be notified of the information within the distance range in which a minor collision between the vehicle and the holder or the movable body that moves together with the holder is anticipated, and
the emergency contact unit sends the information necessary for responding to the accident to the contact determined by the personal information analyzer within the distance range in which a minor collision between the vehicle and the holder or the movable body that moves together with the holder is anticipated.

10. The vehicle-mounted device according to claim 8, wherein
the accident detector detects accident information indicating a position and a situation of the accident, and
the personal information analyzer determines that the accident information detected by the accident detector is the information necessary for responding to the accident, and determines the contact who is to be notified of the information.

11. A portable terminal comprising:
a personal information storage to store personal information of a holder; and
a terminal-side communicator to wirelessly communicate with a vehicle-mounted device provided in a vehicle and send the personal information stored in the personal information storage in a case where the vehicle and the holder or a movable body that moves together with the holder exist within a distance range in which a minor collision between the vehicle and the holder or the movable body is anticipated.

12. An emergency notification system comprising:
a vehicle-mounted device provided in a vehicle; and
a portable terminal, wherein
the vehicle-mounted device includes:
a vehicle-side communicator to wirelessly communicate with the portable terminal and receive personal information of a holder of the portable terminal in a case where the vehicle and the holder or a movable body that moves together with the holder exist within a distance range in which a minor collision between the vehicle and the holder or the movable body is anticipated;
a personal information analyzer to analyze the personal information of the holder received by the vehicle-side communicator, and to determine information necessary for responding to an accident and a contact who is to be notified of the information; and
an emergency contact unit to send the information necessary for responding to the accident to the contact determined by the personal information analyzer, and
the portable terminal includes:
a personal information storage to store the personal information of the holder; and
a terminal-side communicator to wirelessly communicate with the vehicle-mounted device and send the personal information stored in the personal information storage in a case where the vehicle and the holder or the movable body that moves together with the holder exist within the distance range in which a minor collision between the vehicle and the holder or the movable body is anticipated.
